(19) United States
(12) Patent Application Publication
(10) Pub. No.: US 2006/0213314 A1
(43) Pub. Date: Sep. 28, 2006

(54) Steering wheel with two spoke armature

(75) Inventors: William E. Bostick, Saint Clair, MI (US); Larry M. Wilmot, Oxford, MI (US)

Correspondence Address: FOLEY AND LARDNER LLP;SUITE 500, 3000 K STREET NW, WASHINGTON, DC, 20007, US

(73) Assignee: TAKATA-PETRI INC.

(21) Appl. No.: 11/086,756

(22) Filed: Mar. 23, 2005

(51) Int. Cl. B62D 1/04

(52) U.S. Cl. 74/552

(57) ABSTRACT

A steering wheel of hub-and-spoke configuration including a hub, a plurality of spokes and a ring portion, wherein the spokes place the ring into material contact with the hub. The first spoke of the steering wheel includes an armature support, while the second spoke of the steering wheel does not include an armature support. The second spoke may be primarily made from polyurethane foam. The second spoke may be located at a lower portion of the steering wheel, and the lower portion of the steering wheel deforms more easily than a portion of the steering wheel proximate to the first spoke.

### BACKGROUND OF THE INVENTION

Hub-and-spoke automobile steering wheels with three or more spokes are aesthetically pleasing and desirable to perspective automobile purchasers. Moreover, steering wheels having spokes that project downward from the hub (as referenced when the steering wheel is positioned for “straight ahead” driving) are also appealing. Thus, in the case of a three spoke steering wheel, many designs would have a spoke located at about the 6 o'clock position with respect to the steering wheel. In the case of four spoke steering wheel, many designs would have one or two of the spokes located between the 3 o'clock and 9 o'clock positions of the steering wheel. Hereinafter, spokes located between about the 3 o'clock and about the 9 o'clock position will be referred to as “lower spokes.”

FIG. 1 shows an explanatory embodiment of a four spoke steering wheel, where two of the spokes (spokes 130) are lower spokes. FIG. 1 shows a steering wheel 100 with a ring portion 110 and four spokes (120, 130) which connect the ring portion 110 to a hub portion 145. As may be seen, the steering wheel 100 includes a frame 105. The elements making up the frame 105 (elements 115, 125, 135, 145, etc., discussed in greater detail below) are typically fabricated from strong, relatively high load-bearing materials, such as by way of example and not by way of limitation, aluminum, steel, harden plastic, graphic epoxy, reinforced fiberglass etc. These elements are further typically of a design to improve their load-bearing features while reducing weight/material costs (e.g., utilizing “C,” “U,” and “I” shaped elements and aligning the elements so as to place the higher load-bearing geometries in line with the direction of expected higher loads, etc.) In particular, armature supports 125 and 135 are typically of a structural design such that these elements may transfer a substantial amount of steering torque (or in some cases all of the steering torque) that may be applied to the ring 110 to the hub 145. Such a steering wheel design presents an aesthetically pleasing as well as a structurally sound steering wheel which may be used to control the direction of an automobile.

Analysis of simulated crash data for hub-and-spoke steering wheels with the three and four spokes, where one or more of the spokes are located at a lower portion of the steering wheel (i.e., one or more spokes are lower spokes) shows that in the event of a rapid deceleration, such as may occur in a head-on collision with a concrete barrier, a driver's upper body, in particular, a driver's chest, may impact the lower portion of the steering wheel. Since such impact may be unavoidable in certain crash scenarios, the present inventors have determined that it is desirable that the steering wheel absorb at least some of the energy from the impact of the driver's chest onto the steering wheel. Such impact absorption may reduce injury to the driver. However, in a steering wheel having the configuration shown in FIG. 1, where the frame 105 of the steering wheel 100 includes armature supports 125 and 135 (i.e., structural members of significant strength such that significant torque may be applied from the wheel to the hub through the supports) in the spokes 120 and 130, respectively, the ability of the steering wheel (in particular, the lower portion of the steering wheel) to absorb energy is somewhat limited. Because of the structural rigidity of the armature supports 125/135 of the spokes 120/130, the lower portion of the steering wheel will absorb less energy. That is, due to the armature supports 125/135 of the spokes 120/130, which increase the structural rigidity of the lower portion of the steering wheel 100, a driver occupant may be injured in a crash if his or her body impacts the lower portion of the steering wheel because this portion is structurally reinforced by the armature supports, 125/135.

### SUMMARY OF THE INVENTION

One embodiment of the invention relates to a steering wheel of hub-and-spoke configuration, comprising a hub, a plurality of spokes; and a ring portion, wherein the spokes place the ring into material contact with the hub, wherein a first spoke includes an armature support, and wherein a second spoke does not include an armature support.

### BRIEF DESCRIPTION OF THE DRAWINGS

FIG. 1 is a schematic representation of a steering wheel of four spoke configuration with armature supports in each spoke.

FIG. 2 is a schematic representation of a steering wheel of four spoke configuration with armature supports only in the upper spokes.

FIG. 3 is a schematic representation of the frame of the steering wheel of FIG. 2 with the polyurethane foam removed.

### DETAILED DESCRIPTION OF THE PREFERRED EMBODIMENTS

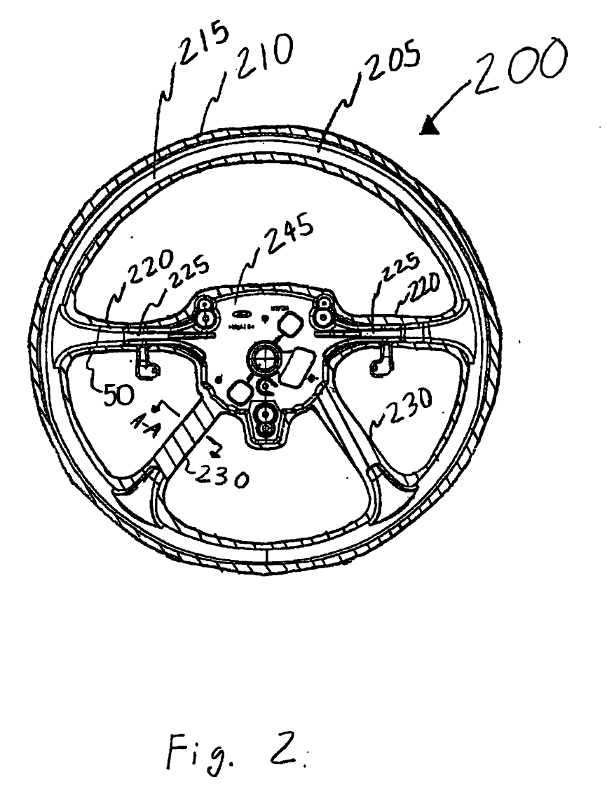

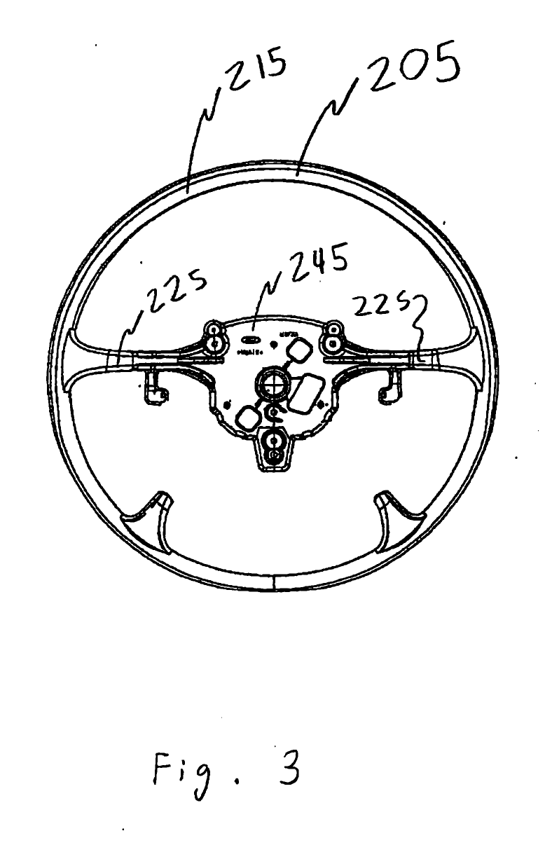

In a first embodiment of the invention, as is exemplary depicted in FIGS. 2 and 3, there is a steering wheel 200 comprising a frame 205. The frame 205 includes a ring 215, armature supports 225, and a hub 245. As may be seen from the Figs., the ring portion 215, the armature supports 225 and the hub 245 are materially connected to each other. In the exemplary embodiment depicted in FIG. 2, the frame 205 is substantially covered by polyurethane foam 50 thus enhancing the feel of the steering wheel, the look of the steering wheel, and providing a barrier between any sharp edges located on the frame and the driver. FIG. 3 depicts the frame 205 of the steering wheel 200 without the polyurethane foam coating 50. (It is noted that FIGS. 2 and 3 schematically depict a steering wheel/steering wheel frame in a reference where the steering wheel would be positioned when the vehicle is driving straight.)

As may be seen from FIG. 2, the steering wheel 200 includes lower spokes 230 located between about the 4 and 5 o'clock positions and between about the 7 and 8 o'clock positions. As may be seen from FIGS. 2 and 3, the frame 205 of the steering wheel 200, according to a first embodiment of the invention, does not have armature supports in the lower spokes 230, whereas armature supports 225 are present in the upper spokes 220. That is, unlike the upper spokes 220 that have armature supports, there are no armature supports in the lower spokes 230.

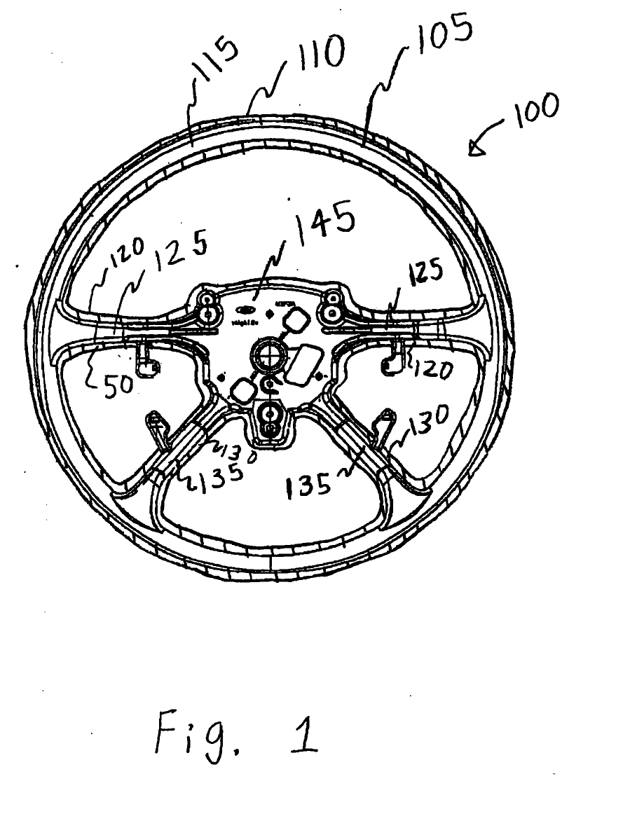

As may be readily seen from FIGS. 2 and 3, other than the armature supports 225 of the upper spokes 220, the bottom half of the ring portion 210 of the steering wheel is not supported by armature supports, unlike the steering wheel of FIG. 1. Thus, in the event that a driver impacts the lower portion of the ring portion 210 of the steering wheel 200 due to a sudden deceleration resulting from, for example, a head-on collusion of the vehicle, the bottom portion of the ring portion 210 is much more likely to effectively deflect in a manner that effectively absorbs at least some of the kinetic energy of the driver's chest. Indeed, the lower portion of the ring 210 is much more likely to substantially deform than the portions of the ring proximate the upper spokes 220. Thus, the driver is less likely to be seriously injured because the bottom portion of the ring portion 210 of the steering wheel 200 may deflect more due to a absence of armature supports in the lower spokes.

As may be seen from FIG. 2, the lower spokes 230, while not serving as significant structural members, are still present. This allows for the aesthetic benefits of a four spoke steering wheel to be obtained, while providing for a steering wheel of improved deflection capabilities. In a first embodiment according to FIG. 2, the lower spokes 230 are entirely formed by polyurethane foam columns (which, in this embodiment, is the same type of foam that covers the upper armatures 225 of the upper spokes 220). That is, in the embodiment of FIG. 2, if a cross-section A-A is taken about normal to the longitudinal axis of the spokes 230, the material of that cross-section would be entirely polyurethane foam. In a first embodiment of the invention, spokes 230 at section A-A are solid in that there are no gaps (other than those naturally occurring due to the use of a “foam”) present in the spokes. Thus, the material at a geometric center of the cross-section A-A of the spoke 230 taken substantially normal to the longitudinal axis of the spokes 230 is polyurethane foam.

As is discussed above and will be discussed in greater detail below, the presence of the lower spokes in the first embodiment is due to a desire to provide an aesthetically pleasing steering wheel that has the above mentioned advantages with respect to driver impact on the lower portion of the steering wheel. It is noted that in other embodiments of the present invention, lower spokes 230 may be used to support control input devices such as a cruise control input device, radio volume control device, etc., and/or may be used to shield wiring extending from the hub to the lower portion of the ring portion.

In some embodiments of the present invention, the spokes 230 in general, and the material of the cross-section A-A of the spokes 230 in particular, may primarily be made from polyurethane foam while also including other material such as, for example, rubber, soft plastics, etc., which will still allow for an effectively deformable lower ring portion.

As noted above, in some embodiments of the invention, the spokes 230 are substantially solid. In other embodiments of the present invention, the spokes 230 may be hollow. That is, by way of example, a cavity may extend parallel to the longitudinal axis to the spokes 230. In some embodiments of the present invention, this cavity may be centered at about a geometric center of the cross-section A-A, while in other embodiments of the present invention, this cavity may be located in other locations. In yet other embodiments of the invention, a cavity of a spherical shape and/or other shapes may be present such that the cavity does not necessarily extend along the longitudinal axis of the spokes 230.

It is noted that in some embodiments in the present invention, a material having a high modulus of elasticity, such as, for example, aluminum, steel, etc., may be included in the spokes 230. (For example, as noted above, wires may run through the spokes 230.) As long as the material having a high modulus of elasticity does not add any substantial structural rigidity to the lower spokes 230, the spokes 230 may be considered to be made up of material that substantially comprises polyurethane foam.

As noted above, the purpose of the upper spokes 220, or more accurately, the purpose of the armature supports 225 in the upper spokes 220 of the wheel 200, is to transfer steering torque imparted to the ring 210 of the wheel 200 during driving, into the hub 245 such that the automobile may be steered. It is noted that in some embodiments of the present invention, it is expected that a limited amount (a relatively small and insubstantial amount) of steering torque may be transmitted through the lower spokes 230 into the hub 245. That is, even though the lower spokes 230 connecting the hub 245 to the lower portions of the steering wheel ring portion 210 are made from polyurethane foam, the polyurethane foam spokes 230 will still transmit “trace” amounts of torque to the hub 245 owing basic principles relating to material science.

Other structural details of the spokes 220/230 of the steering wheel 200 will now be described, but first a hypothetical structural analysis of the steering wheel 200 will be presented to provide a frame of reference for the teachings regarding to these other structural details below. If the ring 210 where to be hypothetically removed from the steering wheel 200 and a torque were applied at locations on the spokes 220/230 where the spokes interface (or, more accurately, formerly interfaced) with the ring portion 210, torque would be transmitted through both the upper spokes 220 owing to the support armatures 225 and through the lower spokes 230 owing to the polyurethane foam construction of the spokes 230. Such hypothetical application of torque will be hereinafter referred to as “individual spoke torque application.”

In such hypothetical torque applications, the amount of torque that could be applied to the hub would be much greater in the case of the upper spokes 220 then in the case of the lower spokes 230. That is, because the torque transferring material of the lower spokes 230 substantially comprises polyurethane foam, while the torque transferring material of the upper spokes 220 comprises steel, aluminum and/or harden plastic due to the armature supports 225, the upper spokes may transfer a much greater torque to the hub than the lower spokes. Thus accordingly to some embodiments of the present invention, the modulus of elasticity of the torque transferring material of the upper spokes 220 is about an order of magnitude or more than the torque transferring material of the lower spokes 230.

Still further, another way of considering the structural features of the spokes 220 and 230 is to analyze the separate torque transferring features of the spokes irrespective to each other. In this regard, torque transferring elements that transfer a substantial amount of individual spoke torque application to the hub, with respect to an individual torque, is an armature support in the upper spokes, 220, while the element that transfers a substantial amount of individual spoke torque application to the hub (again relative to the spoke) is a polyurethane foam element for the lower spokes 230.

As may be readily seen, the upper spokes 220, during normal operation of the steering wheel 200, would likely transfer between about 40 and 55% of an applied steering torque applied to the ring to the hub. That is, assuming that the design and manufacture of the wheel 200 provided for about even distributions of load and torque, the spokes 220 would transfer virtually all of the steering torque to the hub in about equal amounts. Thus, if the applied steering torque is divided by two, each spoke would transfer about half of the total applied steering torque to the hub. However, in some embodiments, as noted above, it is expected that the lower spokes 230 may transfer a limited amount of the steering torque to the hub. Therefore some designs of the steering wheel 200 may include upper spokes that are adapted to transfer a substantial amount of the steering torque applied to the ring 210 to the hub 245, and lower spokes 230 adapted to transfer a minimal amount of the steering torque applied to the ring 210 to the hub 245. Such a design is in keeping with one of the advantages of the invention, which is to provide a steering wheel that has a lower portion that absorbs energy from the impact of a vehicle driver with the steering wheel.

Yet another way of analyzing the steering wheel 200 of a first embodiment of the invention is to compare the torque at which an upper spoke with an armature 225 will fail to that of a failure torque of a lower spoke. Thus, in some designs, each upper spoke is adapted to transfer about 100% of a first torque to the hub before failing, while the lower spokes 230 in some embodiments, would be such that each of the spokes would be adapted to transfer no more than about 5% of the first torque to the hub before failure. In yet other embodiments of the present invention the lower spokes would be adapted to fail at about 2% of the first torque. Indeed in some embodiments the lower spokes would fail at 1% of the first torque. It is noted that by “fail,” it is meant that the spokes deform in a substantial manner rendering the steering wheel unusable for continued typical use.

In some embodiments of the present invention, the upper spokes are adapted to withstand at least about 200 foot-pounds of torque transferred to the hub through each upper spoke without substantial deformation. Conversely, each lower spoke is adapted to substantially deform under an application of about 40 foot-pounds of torque applied through the lower spoke to the hub.

It is noted that while in the first embodiment of the invention, polyurethane foam is used to form the lower spokes 230. However, in other embodiments of the present invention, a wide variety of soft synthetic resins may be used. Still further, other naturally occurring and/or synthetic materials may be used to make the spokes providing that the lower portion of the ring 210 absorbs sufficient energy as detailed above.

Given the disclosure of the present invention, one versed in the art would appreciate that there are other embodiments and modifications within the scope and spirit of the present invention. Accordingly, all modifications attainable by one versed in the art from the present disclosure within the scope and spirit of the present invention are to be included as further embodiments of the present invention.

What is claimed is:

1. A steering wheel of hub-and-spoke configuration, comprising:
a hub;
a plurality of spokes; and
a ring; wherein
the spokes place the ring into material contact with the hub;
wherein a first spoke includes an armature support; and
wherein a second spoke does not include an armature support.

2. The steering wheel of claim 1, wherein the second spoke has a longitudinal axis extending away from the hub, and wherein the material at a geometric center of a cross-section of the second spoke taken substantially normal to the longitudinal axis consists of soft synthetic resin.

3. The steering wheel of claim 1, wherein the second spoke includes a core and has a longitudinal axis extending away from the hub, and wherein the material of a cross-section of the core of the second spoke taken substantially normal to the longitudinal axis consists of soft synthetic resin.

4. The steering wheel of claim 1, wherein the second spoke has a longitudinal axis extending away from the hub, and wherein the material of a cross-section of the second spoke taken substantially normal to the longitudinal axis consists essentially of soft synthetic resin.

5. The steering wheel of claim 1, wherein the second spoke has a longitudinal axis extending away from the hub, and wherein the material of a cross-section of the second spoke taken substantially normal to the longitudinal axis substantially comprises soft synthetic resin.

6. The steering wheel of claim 1, wherein the second spoke has a longitudinal axis extending away from the hub, and wherein the torque-transferring material of the second spoke at a cross-section of the second spoke taken substantially normal to the longitudinal axis structurally substantially comprises soft synthetic resin.

7. The steering wheel of claim 1, wherein the second spoke has a longitudinal axis extending away from the hub, and wherein the torque-transferring element of the second spoke at a cross-section of the second spoke taken substantially normal to the longitudinal axis is a soft synthetic resin column.

8. The steering wheel of claim 1, wherein the first spoke has a longitudinal axis extending away from the hub, wherein the second spoke has a longitudinal axis extending away from the hub, wherein the torque-transferring material of the first spoke at a cross-section of the first spoke taken substantially normal to the longitudinal axis of the first spoke has a modulus of elasticity of at least about an order of magnitude greater than the modulus of elasticity of the torque-transferring material of the second spoke at a cross-section of the second spoke taken substantially normal to the longitudinal axis.

9. The steering wheel of claim 1, further comprising a third and a fourth spoke, wherein the third spoke includes an armature support, wherein the fourth spoke does not include an armature support, and wherein the second and fourth spokes are radially located between the first and third spokes.

10. A vehicle comprising:
a steering wheel column; and
a steering wheel according to claim 1 fixed to the steering wheel column, wherein the second spoke is a lower spoke when the steering wheel is oriented for straight driving of the vehicle.

11. A steering wheel of hub-and-spoke configuration, comprising:
a hub;
a plurality of spokes; and
a ring; wherein
the spokes place the ring into material contact with the hub;
wherein a first spoke includes an armature support;
wherein a second spoke substantially includes a soft synthetic resin; and
wherein the first spoke is substantially structurally stronger than the second spoke.

12. The steering wheel of claim 11, wherein the second spoke has a longitudinal axis extending away from the hub, and wherein the material at a geometric center of a cross-section of the second spoke taken substantially normal to the longitudinal axis consists of soft synthetic resin.

13. The steering wheel of claim 11, wherein the second spoke has a longitudinal axis extending away from the hub, and wherein the material of a cross-section of the second spoke taken substantially normal to the longitudinal axis consists of soft synthetic resin.

14. The steering wheel of claim 11, wherein the second spoke has a longitudinal axis extending away from the hub, and wherein the material of a cross-section of the second spoke taken substantially normal to the longitudinal axis consists essentially of soft synthetic resin.

15. The steering wheel of claim 11, wherein the second spoke has a longitudinal axis extending away from the hub, and wherein the material of a cross-section of the second spoke taken substantially normal to the longitudinal axis substantially comprises soft synthetic resin.

16. The steering wheel of claim 11, wherein the second spoke has a longitudinal axis extending away from the hub, and wherein the torque-transferring material of the second spoke at a cross-section of the second spoke taken substantially normal to the longitudinal axis structurally substantially comprises soft synthetic resin.

17. The steering wheel of claim 11, wherein the first spoke has a longitudinal axis extending away from the hub, wherein the second spoke has a longitudinal axis extending away from the hub, wherein the torque-transferring material of the first spoke at a cross-section of the first spoke taken substantially normal to the longitudinal axis of the first spoke has a modulus of elasticity of at least about an order of magnitude greater than the modulus of elasticity of the torque-transferring material of the second spoke at a cross-section of the second spoke taken substantially normal to the longitudinal axis.

18. The steering wheel of claim 11, further comprising a third and a fourth spoke, wherein the third spoke includes an armature support, wherein the fourth spoke substantially includes a soft synthetic resin, wherein the third spoke is substantially structurally stronger than the fourth spoke, wherein the second and fourth spokes are radially located between the first and third spokes, and wherein the soft synthetic resins are polyurethane foam.

19. A vehicle comprising:
a steering wheel column; and
a steering wheel according to claim 11 fixed to the steering wheel column, wherein the second spoke is a lower spoke when the steering wheel is oriented for straight driving of the vehicle.

20. A steering wheel of hub and spoke configuration, comprising:
a hub;
a plurality of spokes; and
a ring; wherein
the spokes place the ring into material contact with the hub;
wherein a first spoke is adapted to transfer a substantial amount of a first steering torque applied to the ring to the hub; and
wherein a second spoke is adapted to transfer a minimal amount of the first steering torque applied to the ring to the hub.
